(19) United States
(12) Patent Application Publication
(10) Pub. No.: US 2018/0229442 A1
(43) Pub. Date: Aug. 16, 2018

(54) BONDED PERMANENT MAGNETS PRODUCED BY ADDITIVE MANUFACTURING

(71) Applicants: UT-Battelle, LLC, Oak Ridge, TN (US); Iowa State University Research Foundation, Inc., Ames, IA (US); Lawrence Livermore National Laboratory, Livermore, CA (US)

(72) Inventors: Huseyin UCAR, Auburndale, FL (US); Mariappan Parans PARANTHAMAN, Knoxville, TN (US); Orlando RIOS, Knoxville, TN (US); Belther Mojoko MONONO, Edina, MN (US); Brian K. POST, Knoxville, TN (US); Vlastimil KUNC, Knoxville, TN (US); Cajetan I. NLEBEDIM, Ames, IA (US); R. William MCCALLUM, Sante Fe, NM (US); Scott K. MCCALL, Livermore, CA (US)

(21) Appl. No.: 15/432,251

(22) Filed: Feb. 14, 2017

(51) Int. Cl. B29C 67/00; B22F 1/00; B22F 3/20; B22F 3/24; B22F 7/00; B33Y 10/00; B33Y 40/00; B33Y 70/00; B33Y 80/00; C22C 38/00; H01F 41/02; H01F 1/059; H01F 1/057

(52) U.S. Cl. CPC B29C 67/0055; B29K 2075/00; B22F 3/20; B22F 3/24; B22F 7/008; B33Y 10/00; B33Y 40/00; B33Y 70/00; B33Y 80/00; C22C 38/005; C22C 38/002; H01F 41/0253; H01F 1/059; H01F 1/057; B22F 2001/0066; B22F 2003/208; B22F 2003/248; B22F 2301/355; B22F 2302/45; B22F 2998/10; B22F 1/0059

(57) ABSTRACT

A method for producing a bonded permanent magnet, comprising: (i) incorporating a solid precursor material comprising a thermoplastic crosslinkable polymer and magnetic particles into an additive manufacturing device, wherein the crosslinkable polymer has a delayed crosslinking ability; (ii) melting the precursor material by heating it to a temperature of at least and no more than 10° C. above its glass transition temperature; (iii) extruding the melt through the additive manufacturing device and, as the extrudate exits from the nozzle and is deposited on a substrate as a solidified preform of a desired shape, exposing the resultant extrudate to a directional magnetic field of sufficient strength to align the magnetic particles; and (iv) curing the solidified preform by subjecting it to conditions that result in crosslinking of the thermoplastic crosslinkable polymer to convert it to a crosslinked thermoset. The resulting bonded permanent magnet and articles made thereof are also described.

This invention was made with government support under Prime Contract Nos. DE-AC05-000R22725 and AC02-07CH11358 awarded by the U.S. Department of Energy. The government has certain rights in the invention.

### FIELD OF THE INVENTION

The present invention relates generally to bonded permanent magnets and methods for producing them. The invention also relates to additive manufacturing methods, such as 3-D printing, fused deposition modeling (FDM), and fused filament fabrication (FFF).

### BACKGROUND OF THE INVENTION

Permanent bonded magnets are well known. However, current methods for producing them are being significantly challenged by an increasing demand for bonded permanent magnets of various shapes with higher mechanical strength and higher magnetic field strengths. In the conventional process, magnetic particles are admixed with a thermoplastic polymer that functions as a binder. In order to increase the mechanical strength of the thermoplastic polymer, the conventional process typically increases the molecular weight and/or degree of branching in the thermoplastic polymer.

However, increasing the molecular weight and/or degree of branching of the thermoplastic material also generally results in an elevation of the melt viscosity and melting point, all of which impedes flow. In an effort to increase the magnetic field strength, a higher density of magnetic particles (e.g., at least 80 wt %) may be attempted, but doing so generally also results in an elevation of the melt viscosity and melting point. To counteract the resistance to flow, the thermoplastic material is generally heated to a higher temperature at which a more flowable melt results; however, the increased temperature may degrade both the polymer binder and magnetic particles. Considering the above, there would be a significant advantage in a method that could produce permanent bonded magnets of any desired shape and with higher than conventional mechanical strengths and magnetic field strengths, and do so without requiring the unacceptably high elevated temperatures necessary for inducing a sufficiently flowable melt and that could degrade either the polymer binder or magnetic particles.

### SUMMARY OF THE INVENTION

The present disclosure is directed to methods for producing permanent bonded magnets of any of a variety of shapes and with exceptional mechanical and magnetic field strengths. Significantly, the methods described herein do not rely on high molecular weight or crosslinked thermoplastic polymer binders, coupled with sufficiently high temperature to induce melt flow, as generally employed in the art, as the means for producing permanent bonded magnets with higher than conventional mechanical and magnetic field strengths. Instead, the methods described herein employ thermoplastic crosslinkable polymers that have a characteristic of a delayed crosslinking reaction to the extent that a majority of the crosslinking occurs after the solid precursor material has been melted into a flowable form, extruded, and deposited on a substrate. Once the crosslinking occurs, the initial thermoplastic behavior of the polymeric binder changes to thermoset behavior, i.e., the polymeric binder initially behaves as a thermoplastic but changes to a thermoset after crosslinking occurs. For this reason, the crosslinkable polymers employed herein can be considered to possess a hybrid thermoplastic-thermoset characteristic. By virtue of the novel characteristics of the polymer, the method described herein can employ a temperature well under a temperature that could degrade the polymer binder or magnetic particles while at the same time producing a permanent bonded magnet of higher than ordinary increased mechanical and/or magnetic field strength. The mild temperature of the process also results in a lower energy demand and overall greater efficiency and simplicity of the process.

In particular embodiments, the method is an additive manufacturing method that includes the following steps: (i) incorporating a solid precursor material into an additive manufacturing device, the solid precursor material comprising a thermoplastic crosslinkable polymer and particles having a hard magnet composition, wherein the thermoplastic crosslinkable polymer has a characteristic of a delayed crosslinking reaction to the extent that a majority of the crosslinking occurs after the solid precursor material has been melted, extruded, and deposited on a substrate, as provided in subsequent steps; (ii) melting the solid precursor material in the additive manufacturing device by heating the solid precursor material to a temperature of at least and no more than 10° C. above the glass transition temperature of the solid precursor material to produce a melt of the solid precursor material; (iii) extruding the melt through a nozzle of the additive manufacturing device and, as the extrudate exits from the nozzle and is deposited on a substrate as a solidified preform of a desired shape, exposing the resultant extrudate to a directional magnetic field of sufficient strength to align the particles having a hard magnetic composition; and (iv) curing the solidified preform by subjecting the solidified preform to conditions that result in crosslinking of the thermoplastic crosslinkable polymer to convert the thermoplastic crosslinkable polymer to a crosslinked thermoset, to produce a bonded permanent magnet of the desired shape.

### BRIEF DESCRIPTION OF THE FIGURES

FIG. 1. Hysteresis loop at room temperature of a 78 wt. % bonded magnet prepared from a precursor material containing magnetic powder in a hybrid polyurethane matrix.

FIGS. 2A-2H. Optical surface images of a bonded magnet produced using different loadings of Nd₂Fe₁₄B magnetic powders in a poly(ethylene)-co-vinyl acetate (EVA polymer) matrix: 5 wt. %, 10 wt. %, 25 wt. %, 50 wt. %, 60 wt. %, 70 wt. %, 80 wt. %, and 90 wt. % for FIGS. 2A-2H, respectively.

### DETAILED DESCRIPTION OF THE INVENTION

In the disclosed process, a material containing a thermoplastic crosslinkable polymer (i.e., “polymeric binder” or “hybrid polymer”) admixed with particles having a hard magnet composition (i.e., magnetic particles) is employed as a solid precursor material (i.e., feed) in an additive manufacturing device. As further discussed below, the thermoplastic crosslinkable polymer provides the significant advantage of permitting the precursor material to behave as a pliable thermoplastic material at relatively low temperature during deposition of the precursor material, while at the same time permitting the precursor material to transform into a hardened durable non-pliable thermoset state after deposition and construction of the magnetic object.

The additive manufacturing process can be any of the additive processes well known in the art, such as a rapid prototyping unit, such as a fused deposition modeling (FFF) device, or more particularly, a 3D printer. As well known in the art, the additive process generally operates by hot extruding a composite through a die or nozzle of a suitable shape and repeatedly depositing discrete amounts (e.g., beads) of the composite fiber in designated locations to build a structure. The temperature employed in the additive process is generally a temperature at which the composite is extrudable but not in a completely melted state, i.e., a temperature below the melting temperature of the polymer. Upon exiting the die (i.e., nozzle) in the additive processing unit, the composite material cools and solidifies. In the FFF or 3D printing process, the nozzle is moved in precise horizontal and vertical positions as beads of the composite are deposited. The beads of composite are sequentially deposited to build a magnetic object, layer by layer. The nozzle movements and flow rate of the composite are generally controlled by computer software, typically a computer-aided manufacturing (CAM) software package. The FFF or 3D printer builds an object (article) based on instructions provided by a computer program that includes precise specifications of the object to be constructed.

The shape of the object that is ultimately built can be suited to any application in which a magnetic material having a significant degree of mechanical strength is desired, such as electrical motors. Although the shape of the magnetic material ultimately produced can be simple, e.g., a planar object, such as a film or coating of a desired two-dimensional shape (e.g., square or disc), the additive manufacturing process is primarily suited to the production of complex (i.e., intricate) shapes. Some examples of intricate shapes include rings, filled or unfilled tubes, filled or unfilled polygonal shapes having at least or more than four vertices, gears, and irregular (asymmetric) shapes. Other possible shapes include arcs with an angle greater than 90 degrees and less than 180 degrees, preferably in the range 120-160 degrees.

The thermoplastic crosslinkable polymer (i.e., polymeric binder) in the precursor material has a characteristic of a delayed crosslinking reaction to the extent that a majority of the crosslinking occurs after the solid precursor material has been melted, extruded, and deposited on a substrate. By virtue of this crosslinking ability, the polymeric binder employed herein functions initially as a thermoplastic and then as a thermoset after crosslinking. Thus, the polymeric binder employed herein can be considered a hybrid polymer, i.e., having characteristics of both a thermoplastic and a thermoset. However, at the thermoset stage, the polymeric binder forms a three-dimensional covalent network, and thus, cannot revert back to a thermoplastic state, as expected for a thermoset polymer.

In order to possess this hybrid characteristic, the polymeric binder possesses groups that ultimately undergo crosslinking, either with the same or other groups in the same polymer, or with the same or other groups in a different polymer or compound (e.g., a rapid or latent crosslinking agent) that has been admixed with the polymeric binder. In conventional FDM, the polymer feed material is simply melted and extruded directly onto a cold or warm plate, or onto a prior build layer. These applications require materials that are spatially locked in place immediately after deposition and maintain tolerance during thermal cycling. Since out-of-the-box heating requires localized deposition of energy to promote layer-to-layer bonding, part distortion is a limiting factor when building high strength components.

The hybrid polymers used herein exhibit a broad thermal activation window that facilitates rapid pre-polymer formation at slightly elevated temperatures without full crosslinking. The hybrid polymer is preferably a reactive polymer, such as polyurethane and/or epoxy, which may be reacted with rapid or latent crosslinking agents, such as moisture provided by a humid environment in the case of urethanes, or an aromatic amine and a polyphenol in the case of epoxies. Typical FDM employs a three-step process, namely, melt, deposit and solidify, while embodiments of this invention can include a five-step process: melt, partially crosslink to achieve desired viscosity, deposit, solidify, and initiate extensive crosslinking. In other embodiments, application of an electromagnetic field can also be used to align aromatic polymer structures for crosslinking between layers. The formation of chemical bonds across layers can improve z-strength and enable incorporation of a large fraction of second phase reinforcements, such as carbon fiber, both of which are currently limited in polymer 3D printing. The crosslinkable polymers used in the method of this invention also provide the advantage of chemically bonding (crosslinking) layers with underlying or previously deposited layers to improve inter-layer adhesion and strength of the deposited part.

The hybrid crosslinkable polymers according to this invention can minimize distortion during a build, increase layer-to-layer adhesion, and/or minimize anisotropy in the part that results from poor interlayer adhesion. The traditional thermoplastic approach with FDM relies on the molten extruded material to solidify on top of a previous deposit, which is typically held at an elevated temperature, but well below the melting temperature of the material. In this condition, the interaction between the newly extruded material and previous deposit is minimal, as there is very little penetration and entanglement of molecules from the molten material into the previous deposit. Even when the previous deposit is held at an elevated temperature, the surface may become “tacky,” but the intermolecular bonding between the deposition layers remains low.

Using the hybrid polymers according to this invention, the solidification process is a chemically driven polymerization process, rather than solely a thermally driven phase change as with thermoplastics. This invention takes advantage of the unique rheological characteristics of hybrid polymers for additive manufacturing of bonded permanent magnets. As discussed above, the hybrid polymers used herein are solid at room temperature and melt at elevated temperatures, yet can crosslink to form a thermoset. In embodiments of this invention, these polymers act as thermoplastics during deposition, and as thermosets after deposition. During the conventional deposition of thermosets, a monomer material is deposited in liquid form, and the crosslinking process that solidifies the thermoset material is irreversible and may be driven by time, heat, a chemical reaction, and/or irradiation. In the case of additive manufacturing according to embodiments of this invention, the concept is to crosslink the material using a chemical reaction and maintain a low temperature gradient within the part. The catalyst that initiates the crosslinking process may be, for example, a secondary chemical mixed with the deposited material during or just prior to deposition, or the crosslinking may be initiated with exposure to air.

Exemplary hybrid polymers according to this invention include, for example, polyurethanes, epoxy-containing polymers, and polymers containing vinyl acetate units. The hybrid polymer may include a backbone and/or pendant groups that are aromatic, in which case the hybrid polymer may be referred to as an “aromatic polymer”. In embodiments of this invention, the polymer material is prepared with a rapid or latent crosslinking agent, such as moisture provided by a humid environment in the case of urethanes, or an aromatic amine and/or a polyphenol in the case of epoxies. The polymer can be blended with a limited quantity of a first curing agent to obtain a partially reacted pre-polymer at moderate temperatures, such as during melt extrusion, and a second less reactive curing agent, such as a phenolic curing agent, for higher temperature curing.

After the solid precursor material is melted, its viscosity may be adjusted for deposition. In one embodiment, the polymer material in the precursor can be partially crosslinked prior to depositing and additionally or fully crosslinked after depositing and solidifying. As one example, urethanes can be deposited in linearized gel form at elevated temperature and subsequently crosslinked when the material is in place. Depositing in a gel form at an elevated temperature permits fusion between layers, while subsequent crosslinking forms strong bonds between the layers. The viscosity of the polymer at deposition can be controlled not only via temperature variation (such as for thermoplastics), but also by polymer chain length and/or via addition of reinforcements, such as carbon, glass, or aramid fibers. This makes additive manufacturing and/or FDM more feasible for deposition of fiber reinforced materials, since the apparent viscosity can be reduced by using polymers in low viscosity states. Additionally, the crosslinking reaction may enhance chemical adhesion between the polymer and fiber reinforcement, which further improves the mechanical properties of the bonded magnetic part ultimately produced.

In one embodiment of this invention, the hybrid polymer includes one or more multi-component epoxy polymers with a broad thermal activation window to facilitate a rapid pre-polymer formation at slightly elevated temperatures without fully crosslinking the epoxy. The polymer can be prepared from an epoxy blend with rapid and/or latent crosslinking agents, such as an aromatic amine and/or a polyphenol. The pre-polymer is then processed into extrusion-ready pellets, which can be supplied into an FDM or other deposition system. Localized electromagnetic energy (AC field heating, microwave heating, IR lamp, or the like) applied to the deposited polymer aligns the liquid crystalline domains and desirably fully cures the formed material. The wide thermal activation window initially immobilizes the polymer material, while allowing electromagnetic control during the development of the inherent microstructure followed by thermal curing.

Exemplary commercial epoxy precursors include aromatic epoxies (e.g., epoxy bisphenol A) or aromatic/aliphatic epoxies, any of which may be a liquid crystalline epoxy resin material. In the case of aromatic/aliphatic epoxies, the aromaticity enhances the microstructure development under magnetic fields while the aliphatic segments lower the viscosity of the epoxy to enhance the processability. The epoxy can be blended with a limited quantity of an aromatic amine curing agent to obtain a partially reacted pre-polymer at moderate temperatures (near room temperature) and a second less reactive phenolic curing agent for higher temperature curing. This strategy results in a broad thermal activation range that permits extrusion and deposition at lower temperatures and final curing at higher temperatures. The aromaticity of both epoxy and curing agent, as well as functional groups, e.g., the ratio of primary amine and hydroxyl groups, can be tuned for the desired extrudability and subsequent high temperature curing. Incorporation of aromatic segments without sacrificing extrudability and while maintaining the capability to rapidly cure at high temperature under a magnetic field is an important concept for zero-CTE (zero-coefficient of thermal expansion) composites according to this invention. After deposition, electromagnetic processing preferably results in the development of a crystalline microstructure, and then curing by controlled localized heating.

The hybrid polymer may be a homopolymer or copolymer, wherein the term “copolymer” herein refers to polymers having two or more different types of monomer units. The copolymer can be, for example, a strict copolymer having only two different types of monomer units, or a terpolymer, tetrapolymer, or higher copolymer. Moreover, the copolymer can have any suitable arrangement, such as a block, alternating, periodic, random, linear, branched, or graft copolymer arrangement. In particular embodiments, the polymer, in the solid fully crosslinked state and in the absence of reinforcing particles, is useful as a structural material with acceptable tensile strength, e.g., at least or above 5, 10, 20, 50, 100, 150, 200, 250, 300, or 350 MPa (as ultimate strength or yield strength). In other embodiments, the polymer in the fully crosslinked solid state would not ordinarily achieve such acceptable tensile strengths by itself, but achieves such tensile strengths when admixed with the magnetic particles and optionally, carbon or other structural materials, introduced during production of the melt.

The hybrid polymer can have any suitable weight-average molecular weight (M_{w}), such as precisely, about, at least, above, up to, or less than, for example, 10,000,000 g/mol, 5,000,000 g/mol, 1,000,000 g/mol, 500,000 g/mol, 400,000 g/mol, 300,000 g/mol, 200,000 g/mol, 100,000 g/mol, 50,000 g/mol, 10,000 g/mol, 5,000 g/mol, 2,500 g/mol, 2,000 g/mol, 1,500 g/mol, 1,000 g/mol, 500 g/mol, 250 g/mol, 200 g/mol, 150 g/mol, or 100 g/mol, or a M_{w} within a range bounded by any two of the foregoing exemplary values. The polymer may also independently have any suitable number-average molecular weight Mₙ. As used herein, the term “about” generally indicates within ±0.5, 1, 2, 5, or 10% of the indicated value. For example, in its broadest sense, the phrase “about 100 g/mol” can mean 100 g/mol ±10%, which indicates 100±20 g/mol or 90-110 g/mol.

The hybrid polymer can be based on any of the thermoplastic polymers known in the art, provided that the thermoplastic polymer naturally possesses or is modified to possess chemical groups that are crosslinkable with each other or with chemical groups in another polymer or compound admixed with the hybrid polymer. The hybrid polymer may be, or include segments of, for example, any of the following: a polyurethane, polyepoxy, polyamide, polyester (or biopolyester, such as polytrimethylene terephthalate), polyacrylonitrile (PAN), lignin, polycarbonate, polystyrene, polybutadiene, polyether, or polybenzimidazole, or combination thereof. In one instance, a copolymer of any of the above recited polymers is used. In another instance, a physical blend of any of the above recited polymers or copolymers thereof is used.

The particles having a hard magnet composition (i.e., “magnetic particles”) can have any suitable particle size, but typically no more than or less than 1 mm, 0.5 mm, 200 microns, 100 microns, 50 microns, 1 micron, 0.5 micron, 0.2 micron, or 0.1 micron, or a distribution of particles bounded by any two of these values. The magnetic particles can be, for example, nanoparticles (e.g., 1-500 nm) or microparticles (e.g., 1-500 microns). The term “hard magnet composition” refers to any of the ferromagnetic compositions, known in the art, that exhibit a permanent magnetic field with high coercivity, generally at least or above 300, 400, or 500 Oe. Thus, the magnetic particles considered herein are not paramagnetic or superparamagnetic particles.

Typically, the permanent magnet composition is metallic, and often contains at least one element selected from iron, cobalt, nickel, and rare earth elements, wherein the rare earth elements are generally understood to be any of the fifteen lanthanide elements along with scandium and yttrium. In particular embodiments, the permanent magnet composition includes iron, such as magnetite, lodestone, or alnico. In other particular embodiments, the permanent magnet composition contains at least one rare earth element, particularly samarium, praseodymium, and/or neodymium. A particularly well-known samarium-based permanent magnet is the samarium-cobalt (Sm—Co alloy) type of magnet, e.g., SmCo₅ and Sm₂Co₁₇. A particularly well-known neodymium-based permanent magnet is the neodymium-iron-boron (Nd—Fe—B) type of magnet. Other rare earth-containing magnetic compositions include, for example, Nd₂Fe₁₄B, MnBi, Pr₂Co₁₄B, Pr₂Fe₁₄B, and Sm—Fe—N. Particle versions of such magnetic compositions are either commercially available or can be produced by well known procedures, as evidenced by, for example, P. K. Deheri et al., “Sol-Gel Based Chemical Synthesis of Nd₂Fe₁₄B Hard Magnetic Nanoparticles,” Chem. Mater., 22 (24), pp. 6509-6517 (2010); L. Y. Zhu et al., “Microstructural Improvement of NdFeB Magnetic Powders by the Zn Vapor Sorption Treatment,” Materials Transactions, vol. 43, no. 11, pp. 2673-2677 (2002); A. Kirkeminde et al., “Metal-Redox Synthesis of MnBi Hard Magnetic Nanoparticles,” Chem. Mater., 27 (13), p. 4677-4681 (2015); and U.S. Pat. No. 4,664,723 (“Samarium-cobalt type magnet powder for resin magnet”). The permanent magnet composition may also be a rare-earth-free type of magnetic composition, such as a Hf—Co or Zr—Co alloy type of permanent magnet, such as described in Balamurugan et al., Journal of Physics: Condensed Matter, vol. 26, no. 6, 2014, the contents of which are herein incorporated by reference in their entirety. In some embodiments, any one or more of the above-described types of magnetic particles are excluded from the precursor material and resulting bonded permanent magnet produced after additive manufacturing.

The magnetic particles are generally included in the solid precursor material in an amount of at least or above 20 wt. % by weight of the polymer binder and magnetic particles (or alternatively, by weight of the entire solid precursor material). In different embodiments, the magnetic particles are included in an amount of at least or above 20, 30, 40, 50, 60, 70, 80, 90, 92, or 95 wt. %, or in an amount within a range bounded by any two of the foregoing values.

In some embodiments, the solid precursor material further includes non-magnetic particles having a composition that confers additional tensile strength to the bonded magnetic after curing. The non-magnetic particles can be composed of, for example, carbon, metal oxide, or metal carbon particles. The particles may have any suitable morphology, including, for example, spheroidal particles or filaments. The particles may be present in the solid precursor material in any desired amount, e.g., at least or above 1, 2, 5, 10, 20, 30, 40, or 50 wt. %, or in an amount within a range bounded by any two of the foregoing values. The term “filament,” as used herein, refers to a particle having a length dimension at least ten times its width dimension, which corresponds to an aspect ratio (i.e., length over width) of at least or above 10:1 (i.e., an aspect ratio of at least 10). In different embodiments, the filament has an aspect ratio of at least or above 10, 20, 50, 100, 250, 500, 1000, or 5000. In some embodiments, the term “filament” refers only to particles having one dimension at least ten times greater than the other two dimensions. In other embodiments, the term “filament” also includes particles having two of its dimensions at least ten times greater than the remaining dimension, which corresponds to a platelet morphology. Notably, the magnetic particles may also (and independently) have a spheroidal, platelet, or elongated (e.g., filamentous) morphology. In some embodiments, the magnetic particles are filaments having any of the aspect ratios described above. Notably, magnetic particles having an anisotropic (e.g., elongated or filamentous) shape are generally more amenable to alignment in a directional magnetic field.

In particular embodiments, carbon filaments are included in the solid precursor material. The carbon filaments can be, for example, carbon fibers, carbon nanotubes, platelet nanofibers, graphene nanoribbons, or a mixture thereof. In the case of carbon fibers, these may be any of the high-strength carbon fiber compositions known in the art. Some examples of carbon fiber compositions include those produced by the pyrolysis of polyacrylonitrile (PAN), viscose, rayon, lignin, pitch, or polyolefin. The carbon nanofibers may also be vapor grown carbon nanofibers. The carbon fibers can be micron-sized carbon fibers, generally having inner or outer diameters of 1-20 microns or sub-range therein, or carbon nanofibers, generally having inner or outer diameters of 10-1000 nm or sub-range therein. In the case of carbon nanotubes, these may be any of the single-walled or multi-walled carbon nanotubes known in the art, any of which may or may not be heteroatom-doped, such as with nitrogen, boron, oxygen, sulfur, or phosphorus. The carbon filament, particularly the carbon fiber, may possess a high tensile strength, such as at least 500, 1000, 2000, 3000, 5000, or 10,000 MPa. In some embodiments, the carbon filament, particularly the carbon fiber, possesses a degree of stiffness of the order of steel or higher (e.g., 100-1000 GPa) and/or an elastic modulus of at least 50 Mpsi or 100 Mpsi.

In other embodiments, metal oxide filaments are included in the solid precursor material. The metal oxide filaments (also known as metal oxide nanowires, nanotubes, nanofibers, or nanorods), if present, can be, for example, those having or including a main group metal oxide composition, wherein the main group metal is generally selected from Groups 13 and 14 of the Periodic Table. Some examples of Group 13 oxides include aluminum oxide, gallium oxide, indium oxide, and combinations thereof. Some examples of Group 14 oxides include silicon oxide (e.g., glass), germanium oxide, tin oxide, and combinations thereof. The main group metal oxide may also include a combination of Group 13 and Group 14 metals, as in indium tin oxide. In other embodiments, the metal oxide filaments have or include a transition metal oxide composition, wherein the transition metal is generally selected from Groups 3-12 of the Periodic Table. Some examples of transition metal oxides include scandium oxide, yttrium oxide, titanium oxide, zirconium oxide, hafnium oxide, vanadium oxide, niobium oxide, tantalum oxide, chromium oxide, molybdenum oxide, tungsten oxide, manganese oxide, iron oxide, ruthenium oxide, cobalt oxide, rhodium oxide, iridium oxide, nickel oxide, palladium oxide, copper oxide, zinc oxide, and combinations thereof. The metal oxide filament may also include a combination of main group and transition metals. The metal oxide filament may also include one or more alkali or alkaline earth metals in addition to a main group or transition metal, as in the case of some perovskite nanowires, such as CaTiO₃, BaTiO₃, SrTiO₃, and LiNbO₃ nanowires, and as further described in X. Zhu, et al., J. Nanosci. Nanotechnol., 10(7), pp. 4109-4123, July 2010, and R. Grange, et al., Appl. Phys. Lett., 95, 143105 (2009), the contents of which are herein incorporated by reference. The metal oxide filament may also have a spinel composition, as in Zn₂TiO₄ spinel nanowires, as described in Y. Yang et al., Advanced Materials, vol. 19, no. 14, pp. 1839-1844, July 2007, the contents of which are herein incorporated by reference. In some embodiments, the metal oxide filaments are constructed solely of metal oxide, whereas in other embodiments, the metal oxide filaments are constructed of a coating of a metal oxide on a non-metal oxide filament, e.g., silica-coated or germanium oxide-coated carbon nanotubes, as described in M. Pumera, et al., Chem Asian J., 4(5), pp. 662-667, May 2009, and M. Pumera, et al., Nanotechnology, 20(42), 425606, 2009, respectively, the contents of which are herein incorporated by reference. The metal oxide layer may alternatively be disposed on the surface of a metallic filament. The metal oxide filaments may also have any of the lengths and diameters described above.

In other embodiments, metal filaments are included in the solid precursor material. The metal filaments (also known as metal nanowires, nanotubes, nanofibers, or nanorods), if present, can be, for example, those having or including a main group metal composition, such as a silicon, germanium, or aluminum composition, all of which are well known in the art. The metal filaments can also have a composition having or including one or more transition metals, such as nickel, cobalt, copper, gold, palladium, or platinum nanowires, as well known in the art. The metal filaments may also be doped with one or more non-metal dopant species, such as nitrogen, phosphorus, arsenic, or silicon to result in a metal nitride, metal phosphide, metal arsenide, or metal silicide composition. Many of these doped metal compositions are known to have semiconductive properties.

The solid precursor material may also include an anti-oxidant compound. The anti-oxidant is generally of such composition and included in such amount as to help protect the magnetic particles from oxidizing during the additive manufacturing process. In some embodiments, the anti-oxidant is a phenolic compound, such as phenol or a substituted phenol (e.g., 2,6-di-t-butyl-4-methylphenol). In other embodiments, the anti-oxidant is a complexant molecule, such as EDTA. The anti-oxidant is typically included in the solid precursor material in an additive amount, typically up to or less than 5, 2, or 1 wt. %.

The solid precursor material is generally prepared by mixing the polymeric binder (i.e., hybrid polymer) while in a flowable form with magnetic particles by any of the means known in the art for homogeneous mixing of two solid components or a solid component in a viscous component. The mixing process may be manual, or may employ, for example, an axial-flow or radial-flow impeller or other mixing device capable of producing a homogeneous blend. In some embodiments, the precursor includes only the polymer and magnetic particles in the absence of other components.

In some embodiments, the solid precursor material includes one or more additional components that desirably modulate the physical properties of the resulting melt. In particular embodiments, a plasticizer is included in the precursor material, typically to promote plasticity (i.e., fluidity) and to inhibit melt-fracture during the extrusion and deposition process. The one or more plasticizers included in the precursor material can be any of the plasticizers well known in the art and appropriate for the particular polymer being extruded. For example, in a first embodiment, the plasticizer may be a carboxy ester compound (i.e., an esterified form of a carboxylic or polycarboxylic acid), such as an ester based on succinic acid, glutaric acid, adipic acid, terephthalic acid, sebacic acid, maleic, dibenzoic acid, phthalic acid, citric acid, and trimellitic acid. In a second embodiment, the plasticizer may be an ester-, amide-, or ether-containing oligomer, such as an oligomer of caprolactam, wherein the oligomer typically contains up to or less than 10 or 5 units. In a third embodiment, the plasticizer may be a polyol (e.g., a diol, triol, or tetrol), such as ethylene glycol, diethylene glycol, triethylene glycol, glycerol, or resorcinol. In a fourth embodiment, the plasticizer may be a sulfonamide compound, such as N-butylbenzenesulfonamide, N-ethyltoluenesulfonamide, or N-(2-hydroxypropyl)benzenesulfonamide. In a fifth embodiment, the plasticizer may be an organophosphate compound, such as tributyl phosphate or tricresyl phosphate. In a sixth embodiment, the plasticizer may be an organic solvent. The organic solvent considered herein is a compound that helps to soften or dissolve the polymer and is a liquid at room temperature (i.e., a melting point of no more than about 10, 20, 25, or 30° C.). Depending on the type of polymer, the organic solvent may be, for example, any of those mentioned above (e.g., ethylene glycol or glycerol), or, for example, a hydrocarbon (e.g., toluene), ketone (e.g., acetone or butanone), amide (e.g., dimethylformamide), ester (e.g., methyl acetate or ethyl acetate), ether (e.g., tetrahydrofuran), carbonate (e.g., propylene carbonate), chlorohydrocarbon (e.g., methylene chloride), or nitrile (e.g., acetonitrile). In some embodiments, one or more classes or specific types of any of the above plasticizers are excluded from the melt. In some embodiments, the plasticizer or other auxiliary component may be removed from the extrudate by subjecting the extrudate to a post-bake process that employs a suitably high temperature capable of volatilizing the plasticizer or other auxiliary component.

Other (auxiliary) components may be included in the melt in order to favorably affect the physical or other properties of the melt (before or during extrusion) or the final bonded magnet. For example, an electrical conductivity enhancing agent, such as conductive carbon particles, may be included to provide a desired level of conductivity, if so desired. To suitably increase the rigidity of the extruded or final magnetic composite, a hardening agent, such as a crosslinking agent, curing agent, or a filler (e.g., talc), may also be included. To improve or otherwise modify the interfacial interaction between the magnetic particles or auxiliary particles and polymeric binder, a surfactant or other interfacial agent may be included. To impart a desired color to the final composite fiber, a coloring agent may also be included. In other embodiments, one or more classes or specific types of any the above additional components may be excluded from the melt.

In the method described herein, the solid precursor material containing the polymeric binder and magnetic particles is incorporated into an additive manufacturing device where the precursor material is first melted by heating the precursor material to a temperature of at least the glass transition temperature (T_{g}) of the precursor material to produce a melt of the precursor material. In order to avoid a temperature that could denature the magnetic particles, and by virtue of the crosslinkable hybrid polymer, the precursor material is preferably heated to a temperature of no more than 5° C. or 10° C. above the glass transition temperature of the precursor material. In different embodiments, the precursor material is melted and exits the additive manufacturing device (and/or is initially deposited) at a temperature of up to or less than 30° C., 40° C., 50° C., 60° C., 70° C., 80° C., 90° C., 100° C., 120° C., 150° C., 180° C., or 200° C., or a temperature within a range bounded by any two of the foregoing exemplary temperatures. As the selected melt temperature is preferably no more than 5° C. or 10° C. above the glass transition temperature of the precursor material, a selected melt temperature generally also places limits on the glass transition temperature of the precursor material.

The melt is then extruded through a nozzle of the additive manufacturing device. As the extrudate exits the nozzle and is deposited, the extrudate cools, which results in an increase in viscosity and a transition of the extrudate to a semi-solid or gel (i.e., a “solidified preform”). At this stage, an initial substantially incomplete level of crosslinking typically also occurs. According to the invention, as the extrudate exits the nozzle and is being deposited as a solidified preform of a desired shape, the extrudate is exposed to a directional (external and non-varying) magnetic field of sufficient strength to align the particles having a hard magnetic composition. The alignment of the magnetic particles refers to at least an alignment of the individual magnetic fields (or poles) of the magnetic particles. In the case of anisotropically shaped magnetic particles, the alignment also involves a physical alignment, e.g., axial alignment of filamentous particles. The hybrid polymer may also undergo alignment, particularly if the hybrid polymer includes an aromatic component. As the magnetic particles and/or hybrid polymer require an appreciable degree of freedom of movement to align themselves, the exposure to the directional magnetic field should occur at least during the time the precursor material is in melted or partially melted form. Generally, in order for magnetic particles and/or the hybrid polymer to sufficiently re-orient and align in the melt, the melt should possess a melt viscosity of up to or less than 20,000, 50,000, or 100,000 cPs, where cPs refers to a centipoise. However, in order to ensure that the extrudate maintains a shape when deposited, the melt on deposition should have a viscosity of at least 1,000, 2,000, 5,000, or 10,000 cPs. In order to sufficiently align the magnetic particles and/or hybrid polymer, the external magnetic field should generally have a magnetic field strength of at least 0.5 Tesla (0.5 T). In different embodiments, the external magnetic field has a magnetic field strength of about, at least, above, up to, or less than, for example, 0.5, 1, 1.2. 1.5, 2, 2.5, 3, 3.5, 4, 5, 6, 7 or 8 T.

After the melt is deposited, and generally but not necessarily after a complete object of desired shape is constructed with the solidified preform, the solidified preform is cured by subjecting the solidified preform to conditions that result in substantial crosslinking to the extent that the thermoplastic behavior of the solidified preform transitions to thermoset behavior. At the curing stage, the transition to a thermoset generally coincides with an increase in viscosity of the solidified preform to a value substantially above 100,000 cPs, and typically, a value of at least or above 200,000, 500,000, or 1,000,000 cPs, and eventually, a transition to a completely non-flowable solid that may be characterized by the usual properties of a solid, e.g., tensile strength and elasticity.

In some embodiments, substantially complete crosslinking occurs by allowing the solidified preform to cool over time. The length of time may be any suitable period of time (e.g., hours or days) for the solidified preform to undergo substantially complete crosslinking. In other embodiments, the solidified preform is subjected to an energetic source that promotes or induces crosslinking. The energetic source may be, for example, thermal energy, electromagnetic irradiation (e.g., ultraviolet, x-ray or gamma-ray energy), or ion bombardment (e.g., electron or neutron beam irradiation).

Examples have been set forth below for the purpose of illustration and to describe certain specific embodiments of the invention. However, the scope of this invention is not to be in any way limited by the examples set forth herein.

### EXAMPLES

Bonded Permanent Magnet Produced from Hybrid Polyurethane and Magnetic Powder

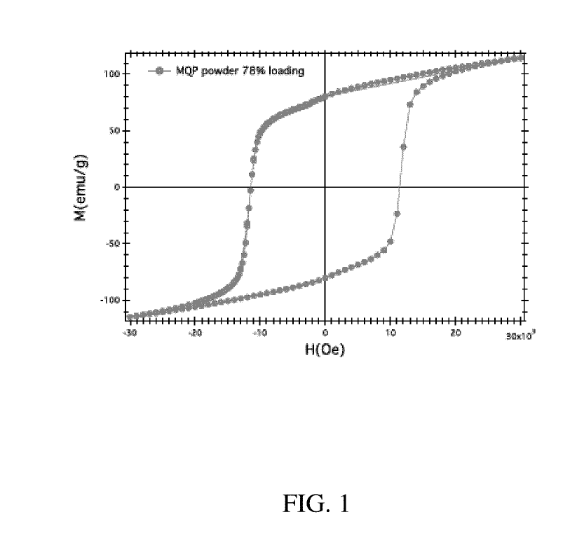

To demonstrate the feasibility of producing a bonded permanent magnet on a small scale, a hybrid polyurethane polymer and 78 wt. % of commercial isotropic Nd₂Fe₁₄B magnet powder were mixed and cast onto a crucible. Polymer bonded magnets were produced by extruding the above mixture. Magnetic hysteresis loops at 300 K of the as-made bonded magnets were measured. For anisotropic magnet powders, the composite was heated to above the melt flow temperature (between 50° C. and 180° C.) to produce a low viscosity melt (matrix viscosity between 1,000 cPs and 100,000 cPs), thereby allowing the powder to reorient in a magnetic field to improve the anisotropy of the composite magnets. FIG. 1 is a hysteresis loop at room temperature for a magnetic composite with 78 wt. % magnetic powder, which was produced by the procedure described above. The magnetic behavior shown in FIG. 1 shows that the bonded magnets have respectable magnetic properties.

Bonded Permanent Magnet Produced from Vinyl Acetate Polymer and Magnetic Powder

Poly(ethylene)-co-vinyl acetate (EVA polymer) was mixed with Nd₂Fe₁₄B magnetic powder using a twin-screw mixer to produce 4-mm diameter filaments. These filaments were reheated to 100° C., aligned in a 1.5 T magnetic field, and cooled to solidification. Using this method, magnetic particles were incorporated into EVA polymer at loadings of 5 wt. %, 10 wt. %, 25 wt. %, 50 wt. %, 60 wt. %, 70 wt. %, 80 wt. %, and 90 wt. %, and each of the resulting composites was used to fabricate a flexible bonded magnet. The Nd₂Fe₁₄B magnetic particles are purely exemplary; the method can be extended to incorporate numerous other types of magnetic particles, such as SmCo₅, Sm₂Co₁₇, Pr₂Co₁₄B, and Sm—Fe—N, and as described earlier above.

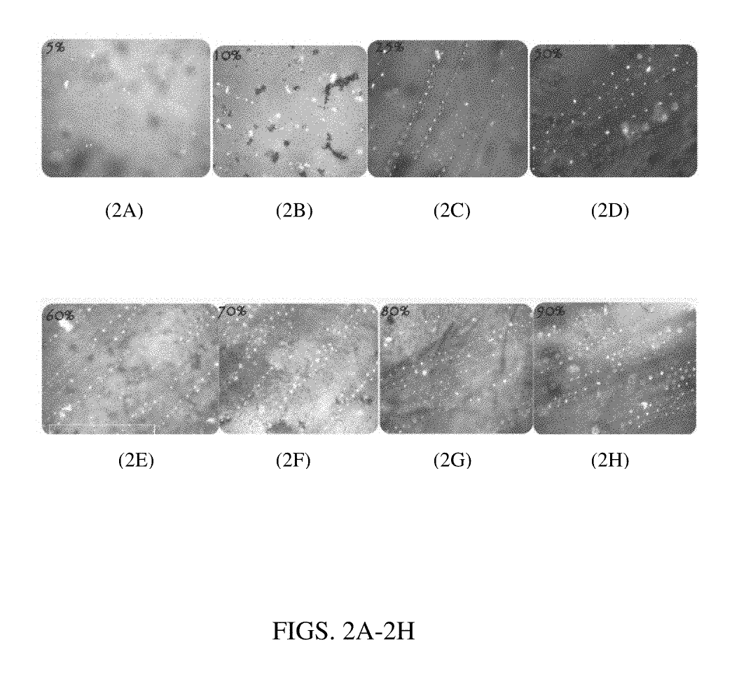

Optical images at 450× magnification of the surfaces of the bonded magnets at each wt. % loading (as above) are shown in FIGS. 2A-2H. The images indicate that all of the magnetic particles align along the direction of the applied magnetic field. Antioxidants, such as EDTA (ethylene diamine triacetic acid) can be added into the polymer-magnet mixtures to avoid oxidation during curing.

While there have been shown and described what are at present considered the preferred embodiments of the invention, those skilled in the art may make various changes and modifications which remain within the scope of the invention defined by the appended claims.

What is claimed is:

1. A method for producing a bonded permanent magnet by additive manufacturing, the method comprising:
(i) incorporating a solid precursor material into an additive manufacturing device, the solid precursor material comprising a thermoplastic crosslinkable polymer and particles having a hard magnet composition, wherein said thermoplastic crosslinkable polymer has a characteristic of a delayed crosslinking reaction to the extent that a majority of the crosslinking occurs after the solid precursor material has been melted, extruded, and deposited on a substrate, as provided in subsequent steps;
(ii) melting said solid precursor material in said additive manufacturing device by heating said solid precursor material to a temperature of at least and no more than 10° C. above the glass transition temperature of said solid precursor material to produce a melt of said solid precursor material;
(iii) extruding said melt through a nozzle of said additive manufacturing device and, as the extrudate exits from the nozzle and is deposited on a substrate as a solidified preform of a desired shape, exposing the resultant extrudate to a directional magnetic field of sufficient strength to align the particles having a hard magnetic composition; and
(iv) curing the solidified preform by subjecting the solidified preform to conditions that result in crosslinking of the thermoplastic crosslinkable polymer to convert said thermoplastic crosslinkable polymer to a crosslinked thermoset, to produce a bonded permanent magnet of the desired shape.

2. The method of claim 1, wherein said thermoplastic crosslinkable polymer is comprised of at least one polymer having crosslinkable groups.

3. The method of claim 1, wherein said solid precursor material further comprises a latent crosslinking agent separate from said thermoplastic crosslinkable polymer.

4. The method of claim 1, wherein said thermoplastic crosslinkable polymer is comprised of a polyurethane, epoxy-containing polymer, or a polymer containing vinyl acetate units.

5. The method of claim 1, wherein said thermoplastic crosslinkable polymer is comprised of an aromatic polymer.

6. The method of claim 5, wherein said aromatic polymer is a liquid crystalline aromatic epoxy-containing polymer.

7. The method of claim 6, wherein said liquid crystalline aromatic epoxy-containing polymer is in admixture with an aromatic amine or phenolic latent crosslinking agent in said solid precursor material.

8. The method of claim 1, wherein said conditions that result in crosslinking of the thermoplastic crosslinkable polymer in step (iv) comprise allowing the solidified preform to cool over time.

9. The method of claim 1, wherein said conditions that result in crosslinking of the thermoplastic crosslinkable polymer in step (iv) comprise subjecting the solidified preform to an energetic source that induces crosslinking.

10. The method of claim 1, wherein said hard magnet composition comprises at least one element selected from iron, cobalt, nickel, and rare earth elements.

11. The method of claim 1, wherein said hard magnet composition has a rare earth composition.

12. The method of claim 11, wherein said hard magnet composition has a samarium-containing, neodymium-containing, or praseodymium-containing composition.

13. The method of claim 1, wherein said solid precursor material further comprises carbon particles.

14. The method of claim 13, wherein said carbon particles are carbon filaments.

15. The method of claim 1, wherein said particles having a hard magnet composition are included in an amount of at least 30 wt. % in said solid precursor material.

16. The method of claim 1, wherein said particles having a hard magnet composition are included in an amount of at least 50 wt. % in said solid precursor material.

17. The method of claim 1, wherein said particles having a hard magnet composition are included in an amount of at least 70 wt. % in said solid precursor material.

18. The method of claim 1, wherein said particles having a hard magnet composition are included in an amount of at least 80 wt. % in said solid precursor material.

19. The method of claim 1, wherein said particles having a hard magnet composition are included in an amount of at least 90 wt. % in said solid precursor material.

20. The method of claim 1, wherein said solid precursor material further comprises an anti-oxidant.

21. The method of claim 20, wherein said anti-oxidant is a phenolic anti-oxidant.

22. The method of claim 1, wherein said particles having a hard magnet composition have an elongated shape.
